(19) United States
(12) Patent Application Publication
(10) Pub. No.: US 2025/0234143 A1
(43) Pub. Date: Jul. 17, 2025

(54) HEARING AID DEVICE

(71) Applicant: COMPAL ELECTRONICS, INC., Taipei City (TW)

(72) Inventors: Ting-Chieh Huang, Taipei City (TW); Kun-Yen Liu, Taipei City (TW); Ting-Wei Wu, Taipei City (TW); Shi-Kuan Chen, Taipei City (TW)

(73) Assignee: COMPAL ELECTRONICS, INC., Taipei City (TW)

(21) Appl. No.: 18/957,840

(22) Filed: Nov. 24, 2024

Related U.S. Application Data
(60) Provisional application No. 63/621,113, filed on Jan. 16, 2024.

(51) Int. Cl. H04R 25/00

(52) U.S. Cl. CPC H04R 25/60

(57) ABSTRACT

Provided is a hearing aid device that includes an earplug, a speaker, a handle, and at least one microphone. A structural profile of the earplug body is mirror symmetrical relative to a plane. The speaker is disposed in the earplug body. The handle extends out of the earplug body from a connection side of the earplug body, and a structural profile of the handle is mirror symmetrical relative to the plane. The microphone is disposed in one or both of the handle and the earplug body.

### CROSS-REFERENCE TO RELATED APPLICATION

This application claims the priority benefit of U.S. provisional application Ser. No. 63/621,113, filed on Jan. 16, 2024. The entirety of the foregoing patent application is hereby incorporated by reference herein and made a part of this specification.

### BACKGROUND

### Technical Field

The disclosure relates to a hearing aid device.

### Description of Related Art

Hearing aid devices are the main auxiliary device for hearing-impaired patients to receive sounds from the outside. Hearing-impaired people who currently wear hearing aids are mostly elderly. However, since existing hearing aid devices are not easy to wear, the elderly need to make additional efforts to learn about the wearing manners.

Moreover, the existing hearing aid devices still need to be separately used for left and right ears; therefore, they are not easy for the elderly users to distinguish and increase the difficulty when worn.

### SUMMARY

The disclosure provides a hearing aid device that provides a usage type of which left and right ears may share to improve the convenience when worn and used.

The hearing aid device of the disclosure includes an earplug body, a speaker, a handle, and at least one microphone. A structural profile of the earplug body is mirror symmetrical relative to a plane. The speaker is disposed in the earplug body. The handle extends out of the earplug body from a connection side of the earplug body, and a structural profile of the handle is mirror symmetrical relative to the plane. The microphone is disposed in one or both of the handle and the earplug body.

The hearing aid device of the disclosure includes an earplug body, a speaker, a handle, and at least one microphone. A structural profile of the earplug body is mirror symmetrical relative to a plane. The speaker is disposed in the earplug body. The handle is pivotally connected to the earplug body from a connection side of the earplug body, and a structural profile of the handle is mirror symmetrical relative to the plane. The microphone is disposed in one or both of the handle and the earplug body.

Based on the above, the hearing aid device of the disclosure includes the earplug body, the speaker, the handle, and the at least one microphone. The structural profile of the earplug body is mirror symmetrical relative to a plane. This allows the earplug body to be worn on the user's left ear and also on the user's right ear to achieve the purpose of left and right ear sharing.

### BRIEF DESCRIPTION OF THE DRAWINGS

FIG. 1A is a schematic view of a hearing aid device according to an embodiment of the disclosure.

FIG. 1B and FIG. 1C are schematic views of the hearing aid device in FIG. 1A from different viewing angles.

FIG. 2 is an integrated schematic view of the hearing aid device in FIG. 1A in different wearing states.

FIG. 3A is a schematic view of a hearing aid device according to another embodiment of the disclosure.

FIG. 3B and FIG. 3C are schematic views of the hearing aid device in FIG. 3A from different viewing angles.

FIG. 3D is a schematic view of the hearing aid device in FIG. 3A in one of the wearing states.

FIG. 4A is a schematic view of a hearing aid device according to another embodiment of the disclosure.

FIG. 4B illustrates the hearing aid device in FIG. 4A from another viewing angle.

FIG. 5A is a schematic view of a hearing aid device according to another embodiment of the disclosure.

FIG. 5B is a schematic view of the hearing aid device in FIG. 5A in another state.

FIG. 6A is a schematic view of a hearing aid device according to another embodiment of the disclosure.

FIG. 6B is a schematic view of the hearing aid device in FIG. 6A in another state.

FIG. 7A is a schematic view of a hearing aid device according to another embodiment of the disclosure.

FIG. 7B is a schematic view of the hearing aid device in FIG. 7A in another state.

FIG. 8A is a schematic view of a hearing aid device according to another embodiment of the disclosure.

FIG. 8B is an exploded view of the hearing aid device in FIG. 8A.

FIG. 9A is a schematic view of a hearing aid device according to another embodiment of the disclosure.

FIG. 9B is an exploded view of the hearing aid device in FIG. 9A.

FIG. 9C is a partial cross-sectional view of the hearing aid device in FIG. 9A.

### DESCRIPTION OF THE EMBODIMENTS

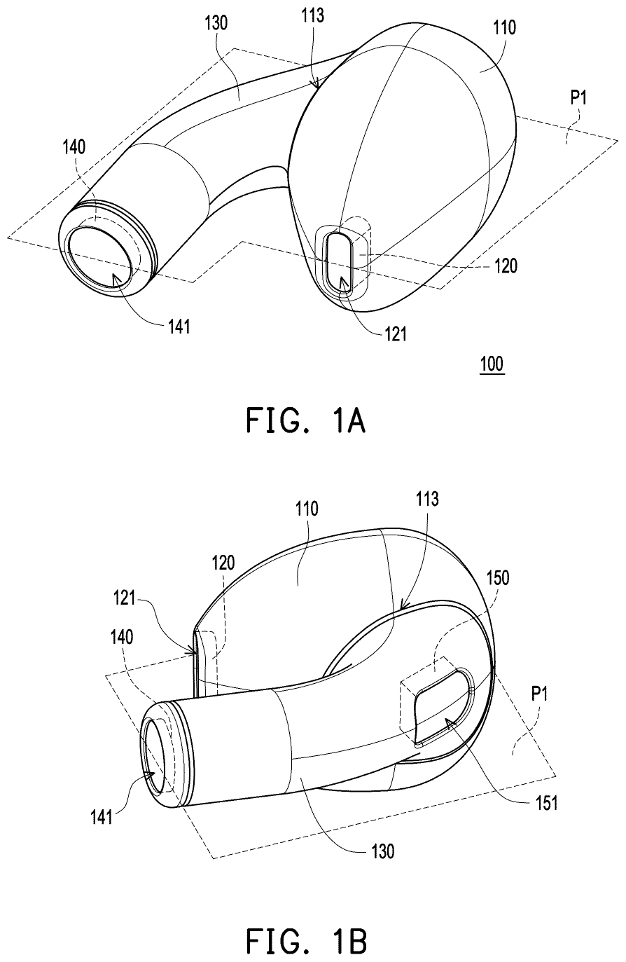

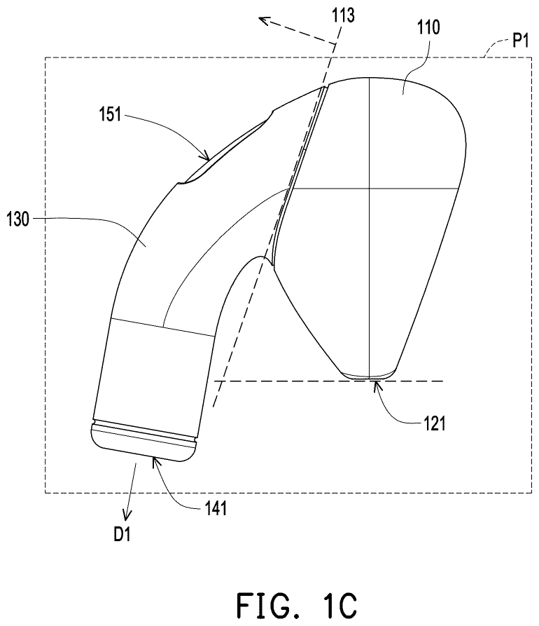

FIG. 1A is a schematic view of a hearing aid device according to an embodiment of the disclosure. FIG. 1B and FIG. 1C are schematic views of the hearing aid device in FIG. 1A from different viewing angles. Please refer to FIG. 1A to FIG. 1C at the same time. In the embodiment, a hearing aid device 100 includes an earplug body 110, a speaker 120, a handle 130 and at least one microphone (a first microphone 140 and a second microphone 150 are taken as an example, but the disclosure is not limited thereto). The structural profile of the earplug body 110 is mirror symmetrical relative to a plane P1. The speaker 120 is disposed in the earplug body 120. The handle 130 extends out of the earplug body 110 from a connection side 113 of the earplug body 110, and the structural profile of the handle 130 is also mirror symmetrical relative to the plane P1. The microphone is disposed in one or both of the handle 130 and the earplug body 110 (for example, the first microphone 140 and the second microphone 150 are disposed in the handle 130 and are respectively located at opposite ends of the handle 130).

In the embodiment, the speaker 120 has a speaker surface 121 exposed on a surface of the earplug body 110, and the speaker surface 121 is also mirror symmetrical relative to the plane P1. Moreover, a sound receiving surface 151 of the second microphone 150 is exposed from the hearing aid device 100 from the connection side 113 and also mirror symmetrical relative to the plane P1. A sound receiving surface 141 of the first microphone 140 is located at an end of the handle 130 away from the earplug body 110 and also mirror symmetrical relative to the plane P1. Here, mirror symmetry means that the target object (such as the foregoing earplug body 110, the speaker surface 121, the sound receiving surface 141, or the sound receiving surface 151) is divided into two parts with the plane P1, and the two parts are based on the plane P1 and present a mirror effect. In addition, as shown in FIG. 1C, projections of the speaker surface 121 and the connection side 113 formed on the plane P1 intersect each other after extending in a direction of the handle 130 (especially in the direction of the first microphone 140). The speaker surface 121 of the speaker 120 and the sound receiving surface 141 of the first microphone 140 both face an extension direction D1 of the handle 130 away from the earplug body 110.

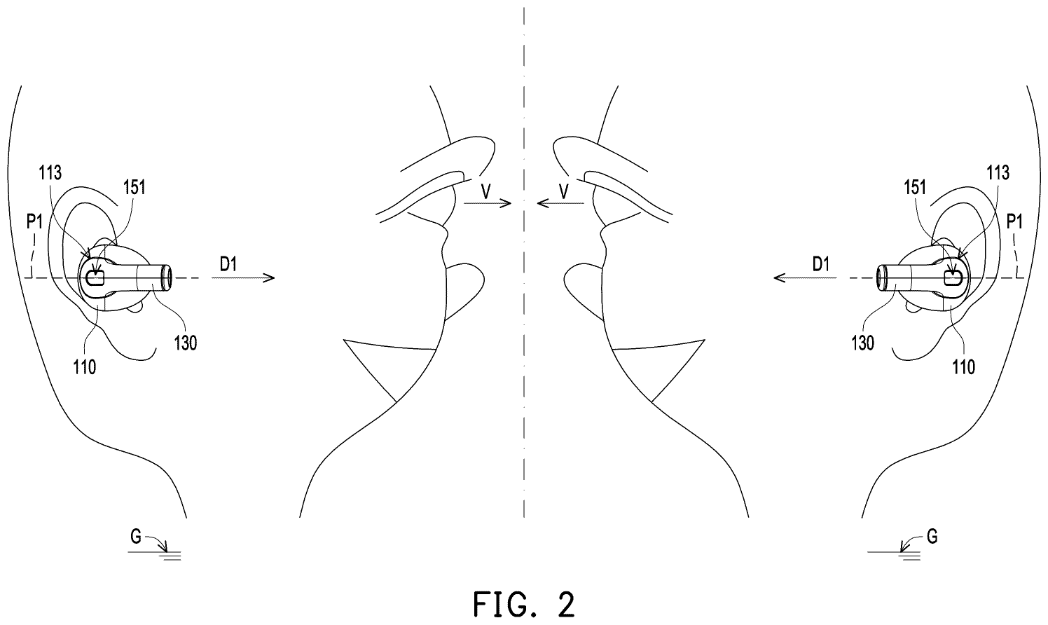

FIG. 2 is an integrated schematic view of the hearing aid device in FIG. 1A in different wearing states. Please refer to FIG. 2 and compare with any one of FIG. 1A to FIG. 1C. As the foregoing structure and disposal, since the handle 130 and the earplug body 110 are an integral structure, the handle 130 of the embodiment may be regarded as a fixed structure extending from the earplug body 110. In this way, based on the characteristics that the foregoing components or structures are mirror symmetrical relative to the plane P1, the same hearing aid device 100 does not need to be additionally distinguished when worn and may be adapted to the left ear and the right ear. At this time, a part of the earplug body 110 facing away from the handle 130 is in contact with the user's left or right ear, and the extension direction D1 faced by the sound receiving surface 141 of the first microphone 140 is also allowed to be a sight direction V of the user. That is, as the user's head moves (or rotates), where the sight reaches is also where the sound receiving object of the first microphone 140 is. Based on the advantages in acoustics, on one hand, sound receiving and sight are allowed to be in the same direction that may improve synchronization of visual and hearing clarity and eliminate using traditional algorithms to adjust the microphone directivity. On the other hand, locations of the microphone and the articulatory cavity are brought closer to improve the signal-to-noise ratio of the microphone. Moreover, the second microphone 150 located at another end of the handle 130 is obviously facing away from the user and toward the external environment. Therefore, the hearing aid device 100 may smoothly achieve the desired loudspeaker and sound receiving effects through the disposal of the speaker 120, the first microphone 140 and the second microphone 150. In practical applications, users do not need to distinguish the adaptation relationship between the left and right ears for a pair of hearing aid device 100 to have the convenience of intuitiveness and wearing-and-using-anytime.

Here, in response to the speaker 120 having been disposed in the earplug body 110, the preferred disposal location for the microphone unit is at the handle 130. In the embodiment, the preferred disposal location is where the first microphone 140 is located, and the second microphone 150 serves as an auxiliary. However, the disclosure does not limit the location of the microphone unit. In other embodiments not shown, if the hearing aid device has enough space, both the handle 130 and the earplug body 110 may be used to accommodate the microphone unit. For example, as shown in FIG. 2, parts of the earplug body 110 and the handle 130 that are exposed when worn may be used as places to accommodate the microphone unit.

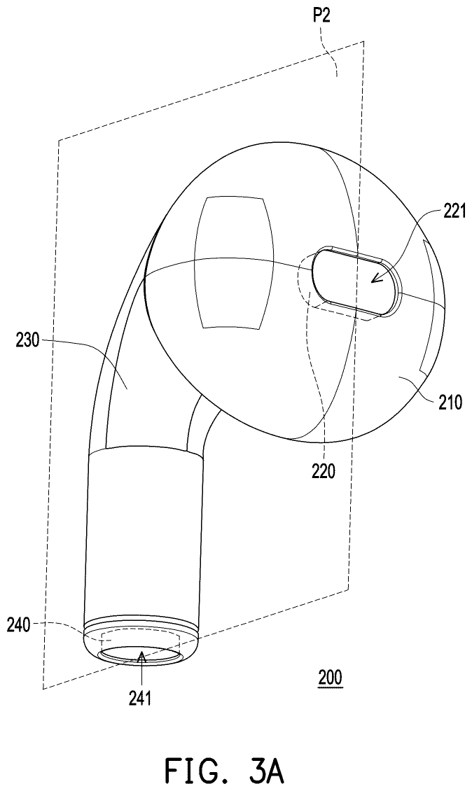

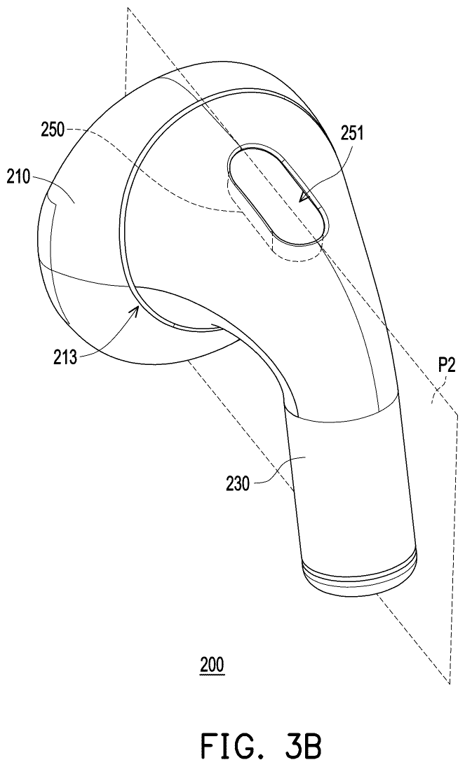

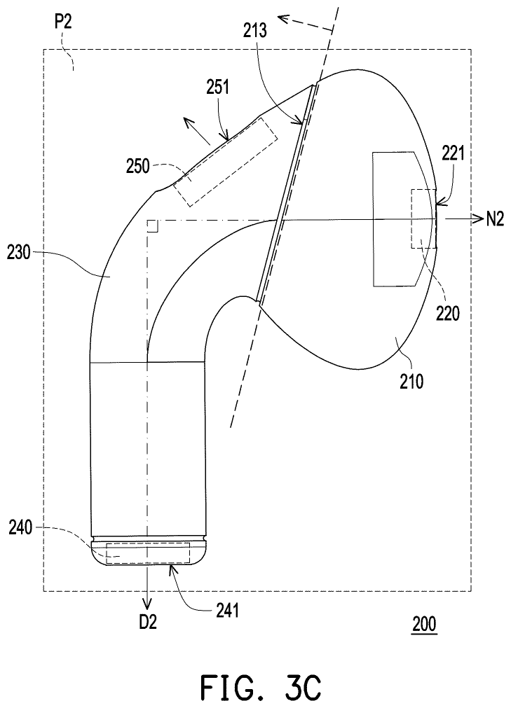

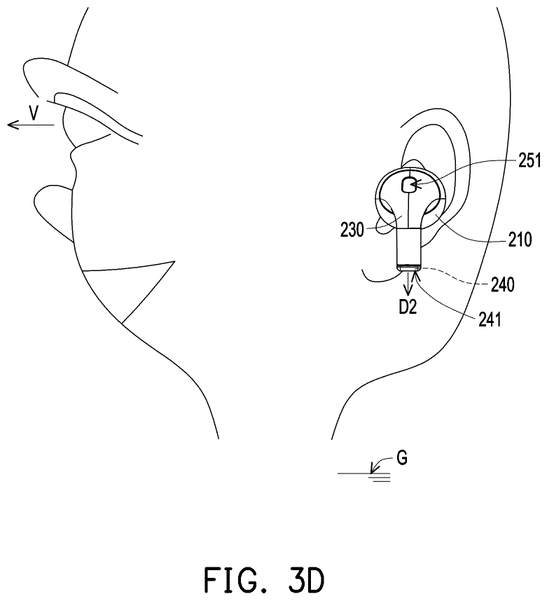

FIG. 3A is a schematic view of a hearing aid device according to another embodiment of the disclosure. FIG. 3B and FIG. 3C are schematic views of the hearing aid device in FIG. 3A from different viewing angles. Please refer to FIG. 3A to FIG. 3C at the same time. In the embodiment, a hearing aid device 200 also adopts the same extended fixed structure as the foregoing embodiment. That is, an earplug body 210 and a handle 230 are an integral structure, a speaker 220 is disposed in the earplug body 210 and exposed on the outside of the earplug body 210 with a speaker surface 221. A first microphone 240 and a second microphone 250 are disposed at opposite ends of the handle 230. A sound receiving surface 241 of the first microphone 240 faces away from the earplug body 210 and is away from a connection side 213 of the earplug body 210 and the handle 230. At the same time, the sound receiving surface 241 faces an extension direction D2 of the handle 230 away from the earplug body 210. A sound receiving surface 251 of the second microphone 250 faces away from the earplug body 210 and is neighboring to the connection side 213. The speaker surface 221, the sound receiving surface 241 and the sound receiving surface 251 respectively face different directions, and the speaker surface 221 faces away from the connection side 213 and the sound receiving surfaces 241 and 251. Moreover, according to the embodiment, projections of a sound emission direction N2 of the speaker surface 221 and the extension direction D2 formed on a plane P2 intersect each other at a right angle after extending in a direction of the second microphone 250.

FIG. 3D is a schematic view of the hearing aid device in FIG. 3A in one of the wearing states. Please refer to FIG. 3B to 3D at the same time. In the embodiment, the earplug body 210 and the handle 230 are mirror symmetrical relative to the plane P2, and the sound receiving surface 221, the sound receiving surface 241 and the sound receiving surface 251 are also mirror symmetrical relative to the plane P2. Accordingly, the hearing aid device 200 may meet the wearing state shown in FIG. 2 in the foregoing embodiment, that is, the hearing aid device 200 may also be a state of left ear and right ear sharing. In the embodiment, in a wearing state, the extension direction D2 that the sound receiving surface 241 faces is a direction facing a ground plane G, instead of facing the sight direction V of the user as shown in FIG. 2. The sound emission direction N2 of the speaker surface 221 is perpendicular to the extension direction D2.

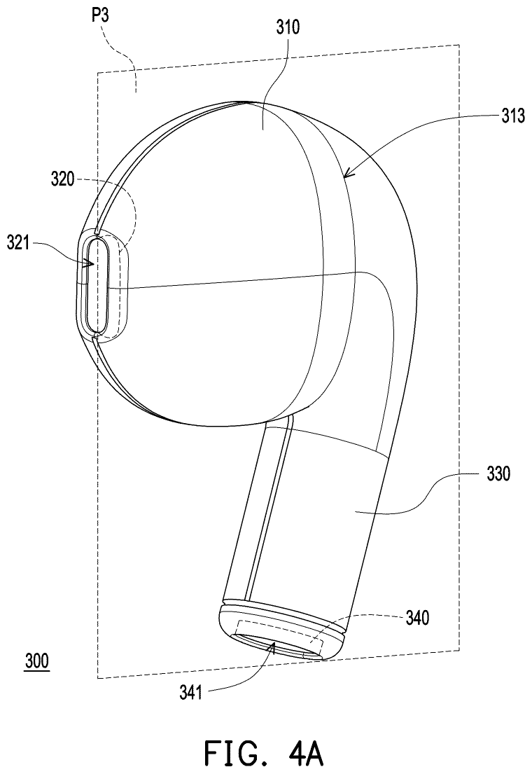

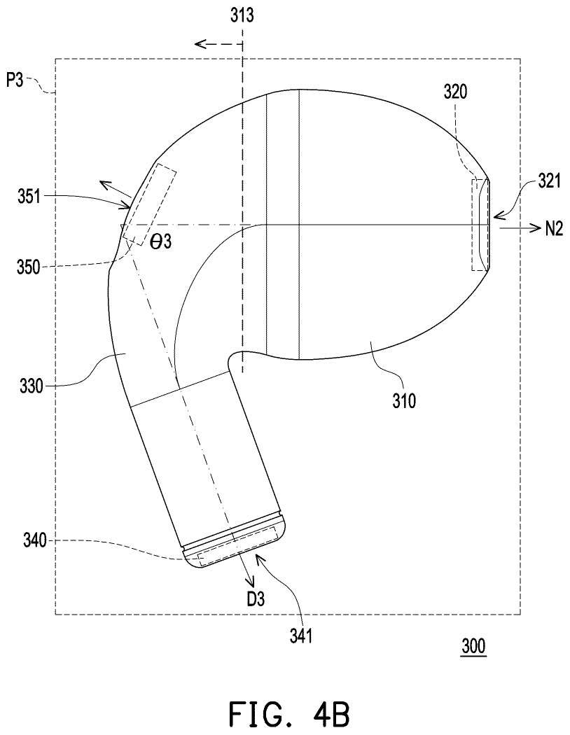

FIG. 4A is a schematic view of a hearing aid device according to another embodiment

of the disclosure. FIG. 4B illustrates the hearing aid device in FIG. 4A from another viewing angle. Please refer to FIG. 4A and FIG. 4B at the same time. Same as the embodiment shown in FIG. 3A to FIG. 3C, an earplug body 310, a handle 330, a speaker surface 321 of a speaker 320, a sound receiving surface 341 of a first microphone 340, a sound receiving surface 351 of a second microphone 350 are individually mirror symmetrical relative to a plane P3. Therefore, the same hearing aid device 300 also have sharing characteristics, and when respectively adapted to the wearing state of the left ear and the right ear shown in FIG. 2 in the embodiment, an extension direction D3 that the sound receiving surface 341 faces is the direction of the ground plane G. Moreover, the speaker surface 321 and the sound receiver surface 341 of the embodiment face different directions, and the speaker surface 321 and the sound receiver surface 351 are separated by a connection side 313 and face away from each other. Different from the embodiment shown in FIG. 3B, in the embodiment, projections of a sound emission direction N3 of the sound surface 321 and the extension direction D3 formed on the plane P3 intersect each other at an acute angle θ3 after extending in a direction of the second microphone 350.

It should also be mentioned that in the embodiments shown in FIG. 1A to FIG. 1C, FIG. 3A to FIG. 3C, FIG. 4A, and FIG. 4B, in order to obtain better control efficiency, the hearing aid device 100, 200 or 300 further includes a G-sensor (not shown) to allow a control module (not shown) of the hearing aid device 100, 200 or 300 to sense and determine whether the hearing aid device belongs to a left-ear wearing state or a right-ear wearing state through the G-sensor.

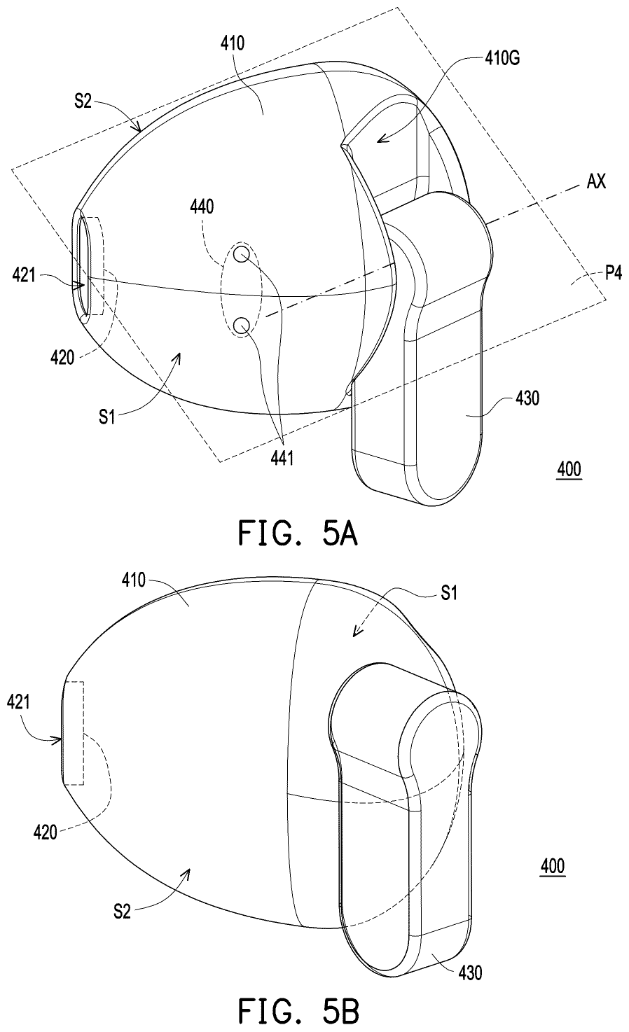

FIG. 5A is a schematic view of a hearing aid device according to another embodiment of the disclosure. FIG. 5B is a schematic view of the hearing aid device in FIG. 5A in another state. Please refer to FIG. 5A and 5B at the same time. Different from the fixed structure of the foregoing embodiment, in a hearing aid device 400 of the embodiment, a handle 430 is pivotally connected in a groove 410G on one side of an earplug body 410 to present a movable state. Furthermore, a speaker 420 has a speaker surface 421 exposed from the earplug body 410. The earplug body 410, the groove 410G, and the speaker surface 421 are respectively mirror symmetrical relative to a plane P4. The handle 430 pivots 180 degrees relative to the earplug body 410 to allow the handle 430 to switch between two relative locations of the earplug body 410. Here, the earplug body 410 has two curved surfaces S1 and S2 facing each other. The handle 430 is pivotally connected in the groove 410G of the curved surface S1 along a pivot axis AX and contacts the user's ear with the curved surface S2. The pivot axis AX is substantially located on the plane P4. Here, taking FIG. 5A as a reference, the state substantially illustrated is that the hearing aid device 400 is worn on the user's left ear. At this time, the handle 430 is located on a location of the curved surface S1. When the handle 430 in FIG. 5A is moved upward (turned 180 degrees from bottom to top), and the handle 430 is converted to a location of the curved surface S2, the hearing aid device 100 may be changed to be worn on the right ear as shown in FIG. 5B. What remains unchanged is that the speaker surface 421 of the speaker 420 is always facing the front of the user, and same as the foregoing embodiment shown in FIG. 2, the handle 430 is always facing the direction of the ground plane G. In addition, a microphone 440 of the embodiment has multiple sound receiving surfaces 441 that are respectively exposed on the earplug body 410 and are mirror symmetrical relative to the plane P4. Regardless of whether the hearing aid device 400 is worn on the user's left ear or right ear, the sound receiving surfaces 441 of the microphone 440 are always facing outward; therefore, it may facilitate message transmission.

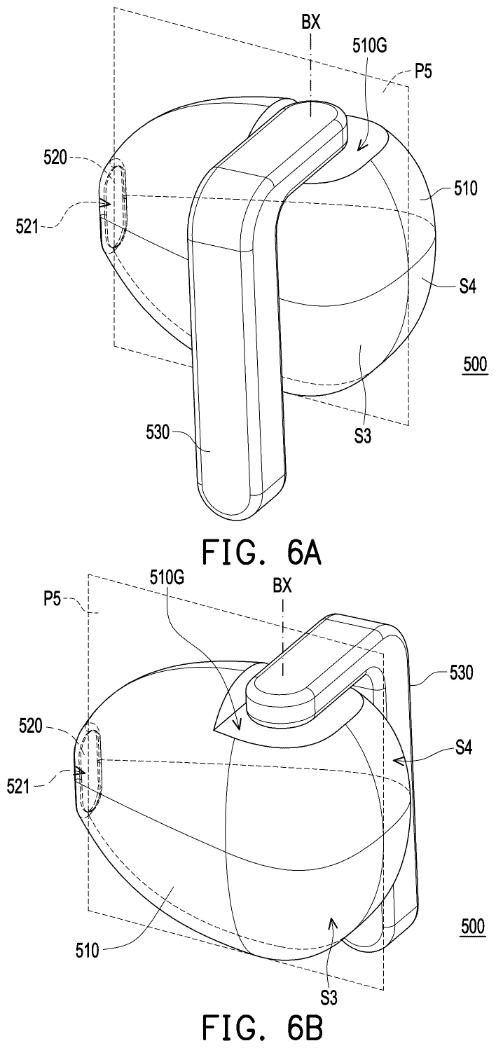

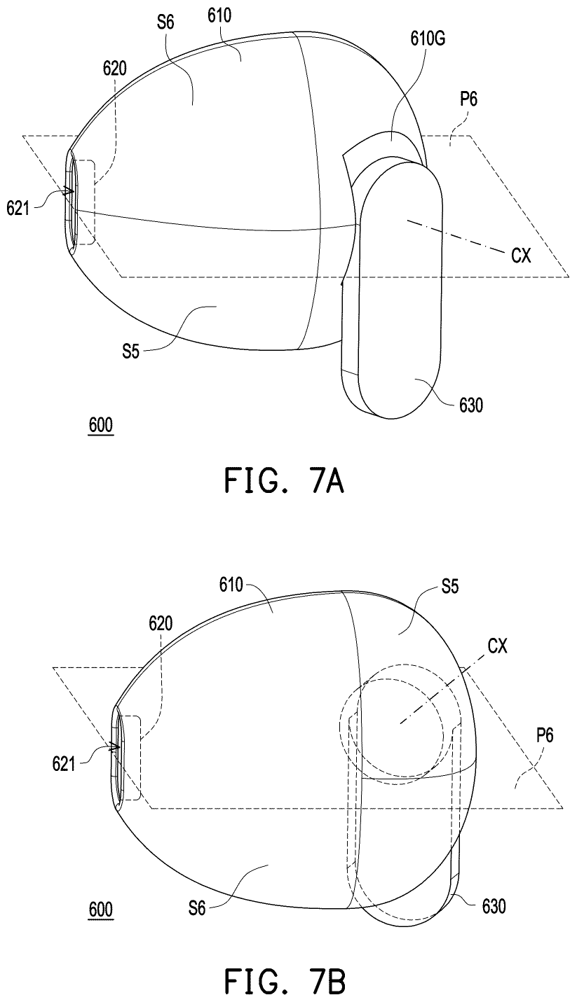

FIG. 6A is a schematic view of a hearing aid device according to another embodiment of the disclosure. FIG. 6B is a schematic view of the hearing aid device in FIG. 6A in another state. Please refer to FIG. 6A and FIG. 6B at the same time. In a hearing aid device 500 of the embodiment, a handle 530 is pivotally connected to a groove 510G on one side of an earplug body 510 to present a movable state. Furthermore, the hearing aid device 500 includes the earplug body 510 and the handle 530 that are pivotally connected to each other. A speaker 520 is disposed in the earplug body 510. The earplug body 510 and the handle 530 are pivotally connected together by a pivot axis BX. The pivot axis BX is located on a plane P5 and is kept a distance from speaker 520. The speaker 520 has a speaker surface 521 exposed from the earplug body 510. As shown in FIG. 6A, the earplug body 510, the groove 510G and the speaker surface 521 are individually mirror symmetrical relative to the plane P5, and the handle 530 pivots 180 degrees relative to the earplug body 510 to allow the handle 530 to switch between two relative locations of the earplug body 510. Here, the earplug body 510 has two opposite curved surfaces S3 and S4 that are substantially separated by the plane P5. The state shown in FIG. 6A is when the hearing aid device 500 is worn on the user's left ear. At this time, the handle 530 is located on a location of the curved surface S3. When the handle 530 rotates along the pivot axis BX and converts to a location of the curved surface S4, the hearing aid device 500 may be disposed to the user's right ear as shown in FIG. 6B. Regardless of whether the hearing aid device 500 is worn on the left ear or right ear of the user, the handle 530 is always back to (facing away from) a direction of the user's face.

On the other hand, the hearing aid device 500 of the embodiment may further include the microphone 440 and the multiple sound receiving surfaces 441 as shown in FIG. 5A. However, the hearing aid device 500 of the embodiment still needs be in response to the driving manner of the handle 530 to allow opposite two sides of the earplug body 510 to be both provided with sound receiving surfaces. Simply put, the switching locations of the handle 530 of the hearing aid device 500 both need to have the foregoing sound receiving surfaces 441. That is, as shown in FIG. 6A or FIG. 6B, after the earplug body 510 is separated into two equal parts by the plane P4, each part needs to be provided with the sound receiving surfaces 441 in response to the handle 530 pivoting and switching between the opposite two surfaces of the earplug body 510.

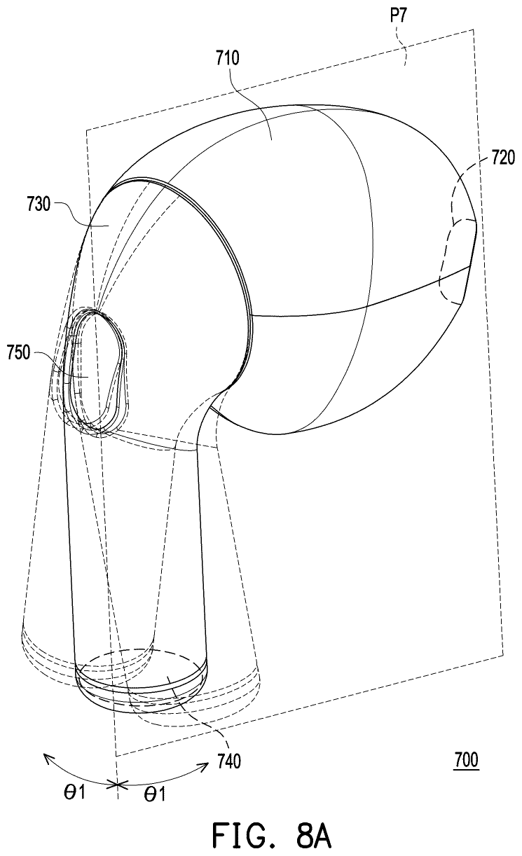

FIG. 7A is a schematic view of a hearing aid device according to another embodiment of the disclosure. FIG. 7B is a schematic view of the hearing aid device in FIG. 7A in another state. A handle 630 of a hearing aid device 600 in the embodiment is pivotally connected to a groove 610G on one side of an earplug body 610 that is similar to the hearing aid device 400 of the foregoing embodiments in FIG. 5A and FIG. 5B. The difference between the two hearing aid devices lies in the manner of movement of the handle. Please refer to FIG. 7A and FIG. 7B at the same time. In the embodiment, a speaker 620 of the hearing aid device 600 has a speaker surface 621 exposed from the earplug body 610. The earplug body 610, the groove 610G, and the speaker surface 621 are respectively mirror symmetrical relative to a plane P6, and the handle 630 pivots 180 degrees relative to the earplug body 610 to allow the handle 630 to switch between two relative locations of the earplug body 610. Here, the earplug body 610 has two curved surfaces S5 and S6 opposite from each other. A pivot axis CX of the handle 630 and the earplug body 610 is located on the plane P6. The pivot axis CX is kept a distance from the speaker 620. The curved surfaces S5 and S6 are separated by the plane P6. As the wearing locations of the earplug body 610 are different, the handle 630 also needs to be rotated to the corresponding curved surface S5 or the corresponding curved surface S6. For example, FIG. 7A shows that the hearing aid device 600 is worn on the user's left ear. (An end of) the handle 630 is rotated to the corresponding curved surface S5 at this time. However, if the hearing aid device 600 needs to be worn on the user's right ear, as shown in FIG. 7B, (the end of) the handle 630 needs to be rotated to the corresponding curved surface S6 at this time.

Here, the two switching locations of the handle 630 and the handle 430 are substantially the same, except for the movement trajectories of the switching process. The earplug body 410 and the earplug body 610 have substantially the same structure, with only slight differences in the recesses for accommodating the handles 630 and 430. Accordingly, the foregoing embodiment may be adapted to relevant structural features of the earplug body 410 and may also be adapted to the earplug body 610 in the same way. For example, the disposal of the multiple sound receiving surfaces 441 of the foregoing microphone 440 is also adapted to the earplug body 610. At the same time, the wearing manner of the hearing aid device 400 is also adapted to the wearing manner of the hearing aid device 600.

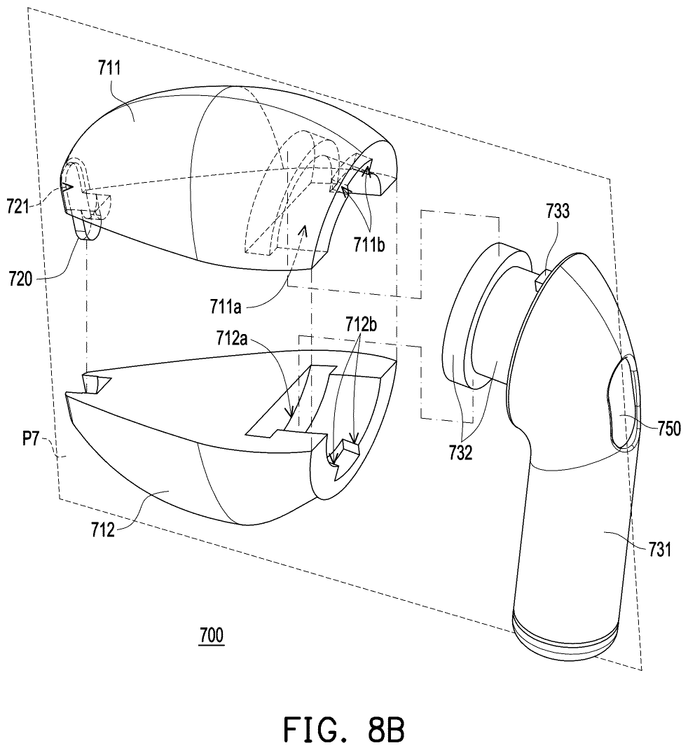

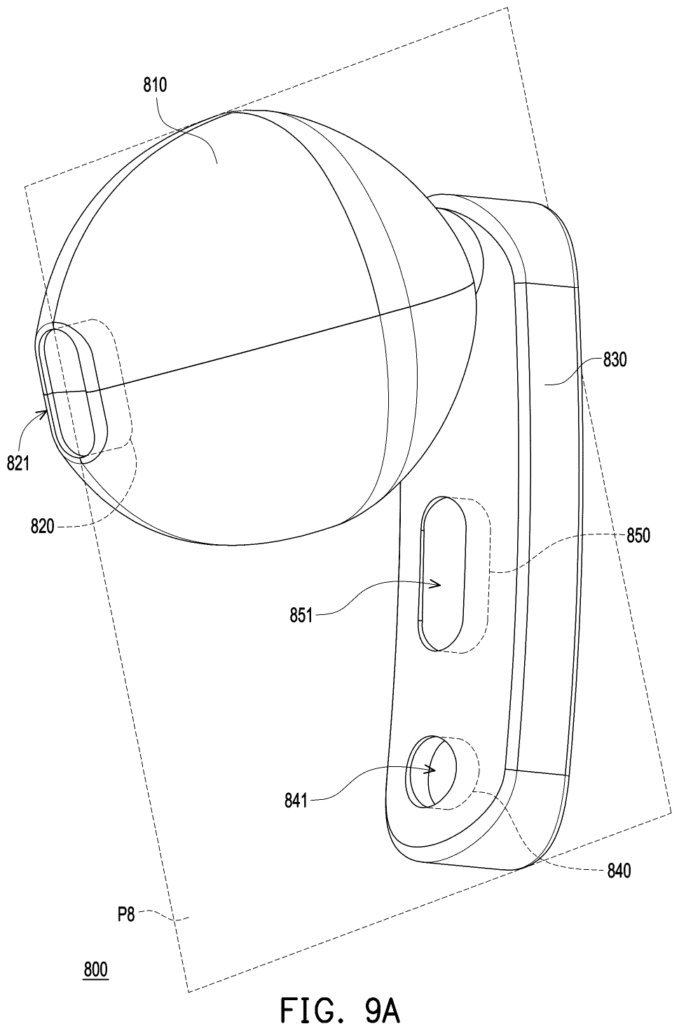

FIG. 8A is a schematic view of a hearing aid device according to another embodiment of the disclosure. FIG. 8B is an exploded view of the hearing aid device in FIG. 8A. Please refer to FIG. 8A and FIG. 8B at the same time. In a hearing aid device 700 of the embodiment, a speaker 720 has a speaker surface 721 exposed from an earplug body 710. The earplug body 710 and the speaker surface 721 are respectively mirror symmetrical relative to a plane P7. A handle 730 pivots at an angle less than 90 degrees relative to the earplug body 710 (as the handle 730 shown as a dotted line in FIG. 8A), where 2*θ1≤90°. The angle θ1 is a fine-adjustable stroke of the handle 730 to facilitate the user to fine-tune the handle 730 relative to the earplug body 710. It is explained here that when the hearing aid device 700 is in a non-fine-tuned state (that is, the default location), the handle 730 is located on a plane P7 and is mirror symmetrical relative to the plane P7, that is, the handle 730 shown as a solid line in FIG. 8A. As shown in FIG. 8B, the earplug body 710 is further divided into a first component 711 and a second component 712 that may be bonded to each other. The handle 730 has an axial portion 732 and a rod 731. The axial portion 732 extends from the rod 731 and is inserted and pivotably connected to a pivot groove (composed of a groove 711a and a groove 712a) formed by the first component 711 and the second component 712.

Moreover, the earplug body 710 further has first stop portions 711b and 712b located in the pivot groove (the first stop portion 711b located in the groove 711a, and the first stop portion 712b is located in the groove 712a). The handle 730 further has a second stop portion 733 located on the axial portion 732. The first stop portions 711b and 712b and the second stop portion 733 are on each other's movement paths, as shown in FIG. 8B, to act accordingly as two extreme end points for fine-tuning the pivot stroke of the handle 730. It is supplementary to note that the manner of disassembly (that is, the first component 711, the second component 712 and the axial portion 732) and the disposal of the stop portions in the embodiment may also be applied in the foregoing hearing aid devices 100, 200 and 300 to allow the foregoing hearing aid devices 100, 200 and 300 to also have fine-tuning functions.

In addition, just like the foregoing embodiment, the hearing aid device 700 in the embodiment also includes a first microphone 740 and a second microphone 750, and the disposal relationship between the sound surface 721, the first microphone 740 and the second microphone 750 may be the same as the foregoing hearing aid devices 100, 200 and 300, so details will not repeated here.

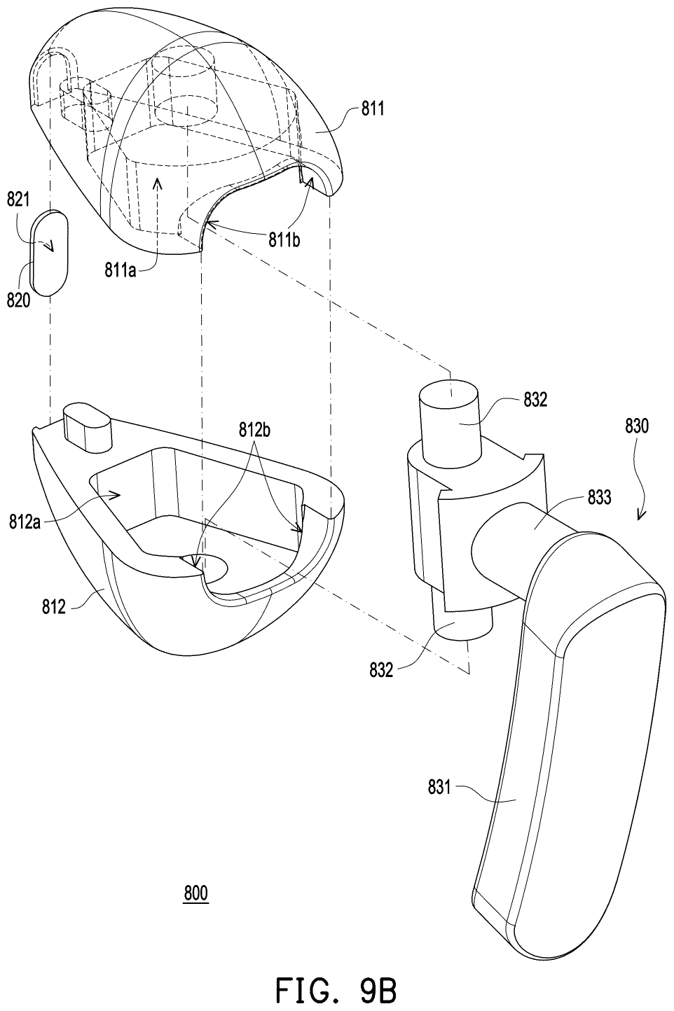

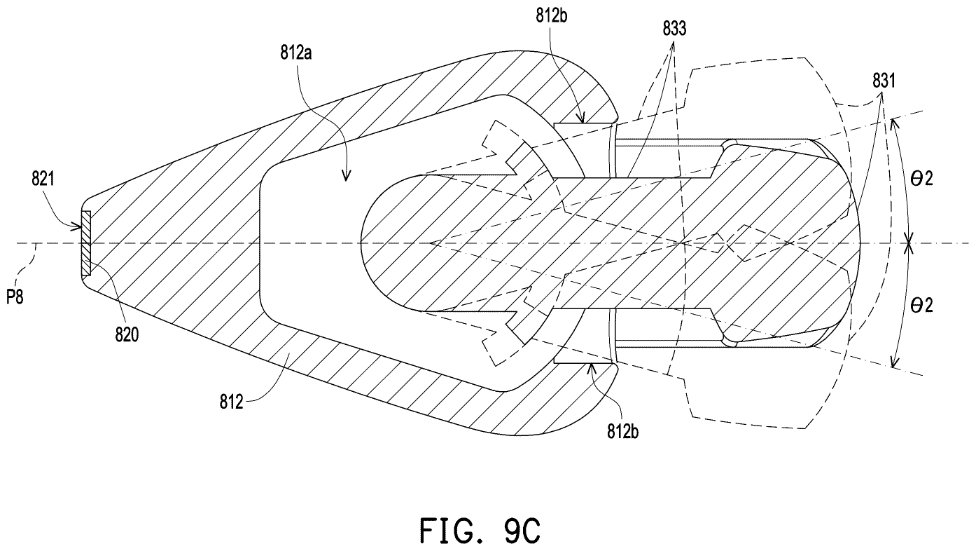

FIG. 9A is a schematic view of a hearing aid device according to another embodiment of the disclosure. FIG. 9B is an exploded view of the hearing aid device in FIG. 9A. FIG. 9C is a partial cross-sectional view of the hearing aid device in FIG. 9A. Please refer to FIG. 9A to FIG. 9C at the same time. In a hearing aid device 800 in the embodiment, an earplug body 810 is mirror symmetrical relative to a plane P8. A speaker 820 has a speaker surface 821 exposed from the earplug body 810. The speaker surface 821 is mirror symmetrical relative to the plane P8. A handle 830 pivots at an angle less than 90 degrees relative to the earplug body 810, that is, 2*θ2≤90°. The angle θ2 is the fine-tuning stroke for the user to operate the handle 830 relative to the earplug body 810. Here, the earplug body 810 is further divided into a third component 811 and a fourth component 812 that may be bonded to each other. The handle 830 has an axial portion 832, a fourth stop portion 833 and a rod 831. The fourth stop portion 833 is connected between the rod 831 and the axial portion 832. The axial portion 832 is inserted and pivotally connected in a pivot groove (composed by a groove 811a of the third component 811 and a groove 812a of the fourth component 812) formed by the third component 811 and the fourth component 812. The axial portion 832 is kept a distance relative to the speaker 820.

Moreover, the earplug body 810 also has third stop portions 811b and 812b located at the opening of the pivot groove. After the handle 830 is assembled to the earplug body 810, the fourth stop portion 833 of the handle 830 is located at the opening of the foregoing pivot groove. Therefore, the third stop portions 811b and 812b and the fourth stop portion 833 are on each other's movement paths to serve as two extreme end points for the handle 830 to fine-tune the pivot stroke. In addition, the hearing aid device 800 further includes a first microphone 840 and a second microphone 850 that are both disposed in the handle 830. Sound receiving surfaces 841 and 851 are exposed on the handle 830 and are mirror symmetrical relative to the plane P8.

In summary, in the embodiments of the disclosure, the hearing aid device includes the earplug body, the speaker, the handle, and at least one microphone. The structural profile of the earplug body is mirror symmetrical relative to a plane. This allows the earplug body to be worn on the user's left ear and also on the user's right ear to achieve the purpose of left and right ear sharing through an intuitive manner of usage.

Moreover, the hearing aid device is provided with a microphone in at least one of the handle and the earplug body to allow the microphone to have a good sound receiving location. The disposal location of a microphone in an embodiment is at the end of the handle and away from the earplug body. The sound receiving surface of the microphone faces the extension direction of the handle and faces away from the earplug body. Therefore, after wearing the hearing aid device, the sound receiving surface may be consistent with the user's sight and facilitate to allow the sight object of the user to be the sound receiving object to achieve a timely and precise sound receiving effect.

What is claimed is:

1. A hearing aid device, comprising:
an earplug body, wherein a structural profile of the earplug body is mirror symmetrical relative to a plane;
a speaker, disposed in the earplug body;
a handle, extending out of the earplug body from a connection side of the earplug body, and a structural profile of the handle is mirror symmetrical relative to the plane; and
at least one microphone, disposed in one or both of the handle and the earplug body.

2. The hearing aid device according to claim 1, wherein the speaker has a speaker surface exposed on a surface of the earplug body, and the speaker surface is mirror symmetrical relative to the plane.

3. The hearing aid device according to claim 2, wherein a sound receiving surface of the microphone is exposed from the hearing aid device from the connection side and mirror symmetrical relative to the plane.

4. The hearing aid device according to claim 2, wherein a sound receiving surface of the microphone is located at an end of the handle away from the earplug body and mirror symmetrical relative to the plane.

5. The hearing aid device according to claim 4, wherein the speaker surface of the speaker and the sound receiving surface of the microphone both face an extension direction of the handle away from the earplug body.

6. The hearing aid device according to claim 5, wherein projections formed by the speaker surface and the connection side on the plane intersect each other after extending in a direction facing the handle.

7. The hearing aid device according to claim 4, wherein the speaker surface of the speaker and the sound receiving surface of the microphone face different directions.

8. The hearing aid device according to claim 7, wherein the sound receiving surface faces an extension direction of the handle away from the earplug body, and the speaker surface faces away from the connection side and the sound receiving surface.

9. A hearing aid device, comprising:
an earplug body, wherein a structural profile of the earplug body is mirror symmetrical relative to a plane;
a speaker, disposed in the earplug body;
a handle, pivotally connected to the earplug body from a connection side of the earplug body; and
at least one microphone, disposed in one or both of the handle and the earplug body.

10. A hearing aid device according to claim 9, wherein the speaker has a speaker surface exposed from the earplug body, the speaker surface is mirror symmetrical relative to the plane, and the handle pivots at an angle of less than 90 degrees relative to the earplug body to allow the handle to perform angular fine-tuning relative to the earplug body.

11. A hearing aid device according to claim 10, wherein the handle is pivotally connected to the earplug body along a pivot axis, the pivot axis passes through the plane and is located on the plane, the earplug body comprises a first component and a second component that are bonded to each other, and the handle has an axial portion that is inserted and pivotally connected to a pivot groove formed by the first component and the second component.

12. The hearing aid device according to claim 11, wherein the earplug body further has a first stop portion located in a pivot groove, the handle further has a second stop portion located in an axial portion, and the first stop portion and the second stop portion are on each other's movement paths.

13. A hearing aid device according to claim 10, wherein the handle is pivotally connected to the earplug body along a pivot axis, the pivot axis is kept a distance relative to the speaker surface, and the earplug body comprises a third component and a fourth component that are bonded to each other, and the handle has an axial portion that is inserted and pivotally connected to a pivot groove formed by the third component and the fourth component.

14. The hearing aid device according to claim 13, wherein the earplug body further has a third stop portion located on the pivot groove, the handle further has a fourth stop portion located on the axial portion, and the third stop portion and the fourth stop portion are on each other's movement paths.

15. The hearing aid device according to claim 9, wherein a sound receiving surface of the microphone is located at an end of the handle away from the earplug body and mirror symmetrical relative to the plane.

16. The hearing aid device according to claim 9, wherein a sound receiving surface of the microphone is located on a side of the handle facing away from the earplug body and mirror symmetrical relative to the plane.

17. A hearing aid device according to claim 9, wherein the speaker has a speaker surface exposed from the earplug body, the speaker surface is mirror symmetrical relative to the plane, and the handle pivots 180 degrees relative to the earplug body to allow the handle to switch between two relative locations of the earplug body.

18. The hearing aid device according to claim 17, wherein the microphone has a plurality of sound receiving surfaces that are respectively exposed on the earplug body and mirror symmetrical relative to the plane.

19. The hearing aid device according to claim 18, wherein the handle is pivotally connected to the earplug body with a pivot axis, and the pivot axis is located on the plane.

20. The hearing aid device according to claim 19, wherein the earplug body has a groove on a side away from the speaker surface, and the groove is mirror symmetrical relative to the plane.

21. The hearing aid device according to claim 19, wherein the pivot axis is kept a distance from the speaker surface.
